(19) United States
(12) Patent Application Publication
(10) Pub. No.: US 2016/0195739 A1
(43) Pub. Date: Jul. 7, 2016

(54) DISPLAY DEVICE AND LIQUID CRYSTAL LENS PANEL

(71) Applicant: SAMSUNG DISPLAY CO., LTD., YONGIN-CITY (KR)

(72) Inventors: CHUN KI CHOI, YONGIN-SI (KR); HAE YOUNG YUN, SUWON-SI (KR); KYUNG HO JUNG, SEONGNAM-SI (KR)

(21) Appl. No.: 14/806,128

(22) Filed: Jul. 22, 2015

(30) Foreign Application Priority Data
Jan. 6, 2015 (KR) 10-2015-0001273

(51) Int. Cl. G02F 1/137; G02F 1/1343

(52) U.S. Cl. CPC G02F 1/137; G02F 1/13439; G02F 1/134309

(57) ABSTRACT

A liquid crystal lens panel includes a lens driving unit that generates a lens voltage for controlling an alignment distribution of a liquid crystal; a first fanout part that includes first fanout wires and second fanout wires connected to the lens driving unit; a second fanout part that includes third fanout wires and fourth fanout wires connected to the lens driving unit; a plurality of bus lines disposed in a peripheral area outside a lens area in which a lens shape is implemented; a plurality of first connection wires that connect first fanout wires and second fanout wires to the bus lines; and a plurality of second connection wires that connect third fanout wires and fourth fanout wires to the bus lines, where the first fanout part and the bus lines or the second fanout part and the bus lines are disconnected from each other.

### CROSS-REFERENCE TO RELATED APPLICATION

This application claims priority under 35 U.S.C. §119 from Korean Patent Application No. 10-2015-0001273, filed in the Korean Intellectual Property Office on Jan. 6, 2015, and all the benefits accruing therefrom, the contents of which are herein incorporated by reference in their entirety.

### BACKGROUND

(a) Technical Field

Embodiments of the present disclosure are directed to a display device and a liquid crystal lens panel.

(b) Discussion of the Related Art

With the development of display device technology, 3 dimensional (3D) image display devices have drawn attention, and various methods of displaying 3D images have been studied.

One of method frequently used in implementing 3D images uses binocular disparity. Binocular disparity involves displaying an image for a left eye and an image for a right eye in the same display device and separately transmitting the two images to the left eye and the right eye of a viewer, respectively. That is, different images are transmitted to both eyes so that a viewer may perceive a 3D effect.

Methods of transmitting separate images to a viewer's left eye and right eye include using a barrier, using a lenticular lens, which is a type of cylindrical lens, etc.

In a 3D image display device that uses a barrier, a slit is formed in the barrier so that images from the display device are divided into a left eye image and a right eye image through the slit to be transmitted to the viewer's left eye and right eye, respectively.

A 3D image display device that uses a lens divides images from 3D image display device into a left eye image and a right eye image by using the lens to change a light path, and displays the left eye image and the right eye image, respectively.

A 2D/3D combined display device capable of displaying a 2D image and a 3D image has been developed, and to this end, a liquid crystal lens panel capable switching the 2D image and the 3D image has been developed.

### SUMMARY

Embodiments of the present disclosure can provide a display device that includes a liquid crystal lens panel and a liquid crystal lens panel that can be used with both an inversion type and a non-inversion type driving method.

An exemplary embodiment of the present disclosure provides a liquid crystal lens panel that includes a lens driving unit for generating a lens voltage for controlling an alignment distribution of a liquid crystal; a first fanout part that includes a plurality of first fanout wires and a plurality of second fanout wires which are connected to the lens driving unit; a second fanout part that includes a plurality of third fanout wires and a plurality of fourth fanout wires which are connected to the lens driving unit; a plurality of bus lines disposed to surround a lens area in which a lens shape is implemented; a plurality of first connection wires that connect at least some of the plurality of first fanout wires to the plurality of bus lines and at least some of the plurality of second fanout wires to the plurality of bus lines; and a plurality of second connection wires that connect at most some of the plurality of third fanout wires to the plurality of bus lines and at least some of the plurality of fourth fanout wires to the plurality of bus lines, wherein the first fanout part and the plurality of bus lines or the second fanout part and the plurality of bus lines are disconnected from each other.

The lens driving unit may output negative voltages with respect to a common voltage to the plurality of first fanout wires and output positive voltages with respect to the common voltage to the plurality of second fanout wires.

Magnitudes of the negative voltages applied to the plurality of first fanout wires may differ from each other, and magnitudes of the positive voltages applied to the plurality of second fanout wires may differ from each other.

The lens driving unit may output negative voltages with respect to a common voltage to the plurality of third fanout wires and output positive voltages with respect to the common voltage to the plurality of fourth fanout wires.

Magnitudes of the negative voltages applied to the plurality of third fanout wires may differ from each other, and magnitudes of the positive voltages applied to the

The liquid crystal lens panel may further include a plurality of linear electrodes disposed in the lens area, wherein groups of adjacent linear electrodes are formed into zones; a plate electrode disposed to face the plurality of linear electrodes and to which a common voltage is applied; and a liquid crystal layer interposed between the plurality of linear electrodes and the plate electrode.

The liquid crystal lens panel may further include a plurality of third connection wires which connect the plurality of linear electrodes and the plurality of bus lines.

When the first fanout part and the plurality of bus lines are disconnected from each other, the liquid crystal lens panel may be driven by a non-inversion method in which a polarity of the voltages applied to the plurality of linear electrodes is not inverted for each zone.

When the second fanout part and the plurality of bus lines are disconnected from each other, the liquid crystal lens panel may be driven by an inversion method in which a polarity of the voltages applied to the plurality of linear electrodes is inverted for each zone.

A polarity of the voltages applied to the plurality of bus lines through the first fanout part and a polarity of the voltages applied to the plurality of bus lines through the second fanout part may differ from each other in at least one bus line.

Another exemplary embodiment of the present disclosure provides a liquid crystal lens panel that includes: a plurality of linear electrodes disposed in a lens area of the liquid crystal lens panel, wherein groups of adjacent linear electrodes are formed into zones; a plate electrode disposed to face the plurality of linear electrodes and to which a predetermined common voltage is applied; a lens driving unit for generating a lens voltage applied to the plurality of linear electrodes; a first fanout part that includes a plurality of first fanout wires and a plurality of second fanout wires which are connected to the lens driving unit; a second fanout part that includes a plurality of third fanout wires and a plurality of fourth fanout wires which are connected to the lens driving unit; and a plurality of bus lines disposed in a peripheral area of the liquid crystal lens panel that surrounds the lens area and that are connected to the plurality of linear electrodes, wherein a polarity of the voltages applied to the plurality of bus lines through the first fanout part and a polarity of the voltages applied to the plurality of bus lines through the second fanout part differ from each other in at least one bus line.

When the first fanout part and the plurality of bus lines are disconnected from each other, the liquid crystal lens panel may be driven by a non-inversion method in which a polarity of the voltages applied to the plurality of linear electrodes is not inverted for each zone.

Magnitudes of negative voltages applied to the plurality of first fanout wires may differ from each other, and magnitudes of positive voltages applied to the plurality of second fanout wires may differ from each other.

When the second fanout part and the plurality of bus lines are disconnected from each other, the liquid crystal lens panel may be driven by an inversion method in which a polarity of the voltages applied to the plurality of linear electrodes is inverted for each zone.

Magnitudes of the negative voltages applied to the plurality of third fanout wires may differ from each other, and magnitudes of the positive voltages applied to the plurality of fourth fanout wires may differ from each other.

The liquid crystal lens panel may further comprise a plurality of first connection wires configured to connect the plurality of first fanout wires and the plurality of second fanout wires to the plurality of bus lines; and a plurality of second connection wires configured to connect at least one of the plurality of third fanout wires and the plurality of fourth fanout wires to the plurality of bus lines.

The lens driving unit may output negative voltages with respect to the common voltage to the plurality of first fanout wires and output positive voltages with respect to the common voltage to the plurality of second fanout wires.

The lens driving unit may output negative voltages with respect to the common voltage to the plurality of third fanout wires and output positive voltages with respect to the common voltage to the plurality of fourth fanout wires.

The liquid crystal lens panel may further comprise a liquid crystal layer interposed between the plurality of linear electrodes and the plate electrode, and a plurality of third connection wires which connect the plurality of linear electrodes and the plurality of bus lines.

Another exemplary embodiment of the present disclosure provides a display device that includes a display panel configured to display an image; and a liquid crystal lens panel positioned in front of a surface on which the image is displayed. The liquid crystal lens panel includes a first substrate and a second substrate facing each other; a first electrode layer including a plurality of linear electrodes which extends in first direction on the first substrate; a second electrode layer disposed on the second substrate and to which a predetermined common voltage is applied; a liquid crystal layer interposed between the first substrate and the second substrate; a lens driving unit configured to generate a lens voltage for controlling an alignment distribution of a liquid crystal; a first fanout part including a plurality of first fanout wires and a plurality of second fanout wires which are connected to the lens driving unit; a second fanout part including a plurality of third fanout wires and a plurality of fourth fanout wires which are connected to the lens driving unit; and a plurality of bus lines which is disposed in a peripheral area outside a lens area in which a lens shape is implemented area and that are connected to the plurality of linear electrodes, wherein the first fanout part and the plurality of bus lines or the second fanout part and the plurality of bus lines are disconnected from each other.

According to the exemplary embodiment of the present disclosure, it is possible to manufacture a liquid crystal lens panel that can be with both an inversion type and a non-inversion type driving method. It is unnecessary to manufacture a liquid crystal lens panel having a separate wire structure for the driving methods.

### BRIEF DESCRIPTION OF THE DRAWINGS

FIG. 1 illustrates a schematic structure of a display device and a method of forming a 2D image according to an exemplary embodiment of the present disclosure.

FIG. 2 illustrates a schematic structure of a display device and a method of forming a 3D image according to an exemplary embodiment of the present disclosure.

FIG. 3 is a perspective view of a liquid crystal lens panel included in a display device according to the exemplary embodiment of the present disclosure.

FIG. 4 is a cross-sectional view of a liquid crystal lens panel of FIG. 3 taken along line IV-IV.

FIG. 5 is one example of a plan view in an xy plane of a liquid crystal lens panel of FIG. 3.

FIG. 6 is another example of a plan view in the xy plane of a liquid crystal lens panel of FIG. 3.

FIG. 7 is a graph that illustrates a phase delay change according to a position of a phase modulation type Fresnel zone plate.

FIG. 8 is a cross-sectional view that illustrates a part of a unit lens in a unit element according to an exemplary embodiment of the present disclosure.

FIG. 9 illustrates a phase delay as a function of position in a unit element of FIG. 8 according to an exemplary embodiment of the present disclosure.

FIG. 10 illustrates an example of a voltage applied to a first electrode layer of a unit element in a liquid crystal lens panel according to an exemplary embodiment of the present disclosure.

FIG. 11 illustrates another example of a voltage applied to a first electrode layer of a unit element in a liquid crystal lens panel according to an exemplary embodiment of the present disclosure.

FIG. 12 is a plan view that illustrates a wire structure of a liquid crystal lens panel according to an exemplary embodiment of the present disclosure.

FIGS. 13 and 14 illustrate one example of a wire structure of a region S of FIG. 12.

FIGS. 15 and 16 illustrate another example of a wire structure of the region S of FIG. 12.

### DETAILED DESCRIPTION OF EXEMPLARY EMBODIMENTS

Embodiments of the present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure. Like reference numerals may designate like elements throughout the specification.

Throughout this specification and the claims that follow, when it is described that an element is “coupled” to another element, the element may be “directly coupled” to the other element or “electrically coupled” to the other element through a third element. It will be understood that when an element such as a layer, film, region, or substrate is referred to as being “on” another element, it can be “directly on” the other element or intervening elements may also be present.

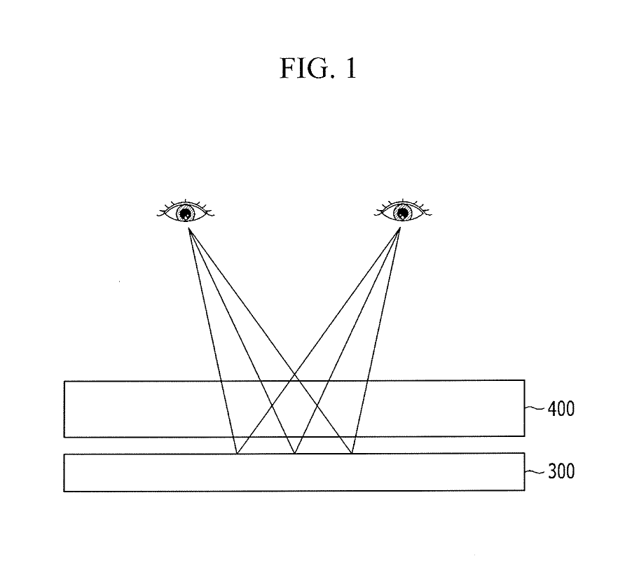

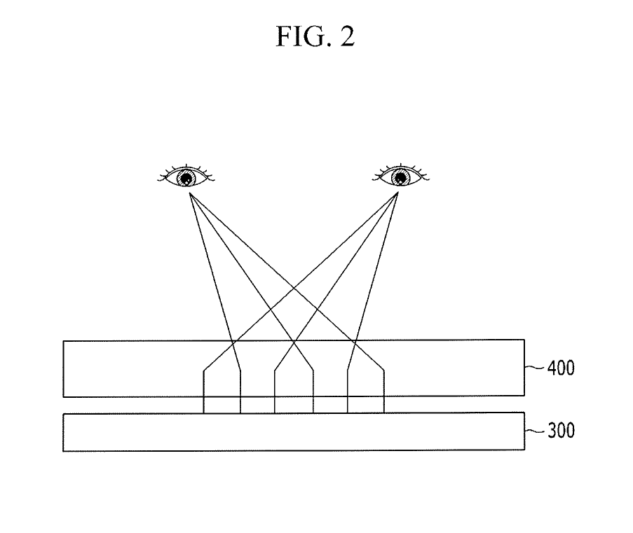

FIG. 1 illustrates a schematic structure of a display device and a method of forming a 2D image according to an exemplary embodiment of the present disclosure. FIG. 2 illustrates a schematic structure of a display device and a method of forming a 3D image according to an exemplary embodiment of the present disclosure.

Referring to FIGS. 1 and 2, a display device includes a display panel 300 for displaying an image, and a liquid crystal lens panel 400 positioned in front of a surface on which the image of the display panel 300 is displayed. The display panel 300 and the liquid crystal lens panel 400 may operate in 2D mode or 3D mode.

The display panel 300 may be any of various types of display panels, such as a plasma display panel, a liquid crystal display, or an organic light emitting display. The display panel 300 includes a plurality of pixels arranged in a matrix form that display an image. The display panel 300 displays one 2D image in 2D mode, but may display images such as a right-eye image and a left-eye image that correspond to various viewing zones by spatial or temporal division methods in 3D mode. For example, in a 3D mode, the display panel 300 may alternately display the right-eye image and the left-eye image for each pixel in a column.

The liquid crystal lens panel 400 can operate in 2D mode so that the image displayed on the display panel 300 may be perceived as a 2D image or in a 3D mode so that the image may be perceived as a 3D image. The liquid crystal lens panel 400 allows the image displayed on the display panel 300 to be transmitted as is in 2D mode. The liquid crystal lens panel 400 divides the image displayed on the display panel 300 into viewing zone in 3D mode. That is, the liquid crystal lens panel 400 operating in 3D mode focuses a multi-view image displayed on the display panel 300 that includes a left-eye image and a right-eye image on a corresponding viewing zone for each view image by diffracting and refracting light.

FIG. 1 illustrates a case where the display panel 300 and the liquid crystal lens panel 400 operate in 2D mode. In 2D mode, the same image reaches the left eye and the right eye to be perceived as 2D image.

FIG. 2 illustrates a case where the display panel 300 and the liquid crystal lens panel 400 operate in 3D mode. The liquid crystal lens panel 400 divides and refracts the image of the display panel 300 into left-eye and right eye viewing zones, and as a result, a 3D image is perceived.

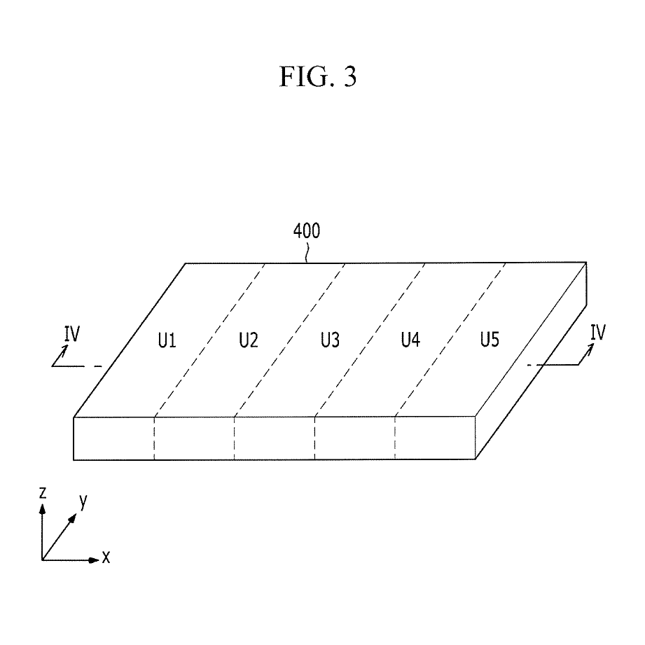

Hereinafter, a schematic structure of the liquid crystal lens panel 400 for operating in 3D mode will be described with reference to FIGS. 3 to 7.

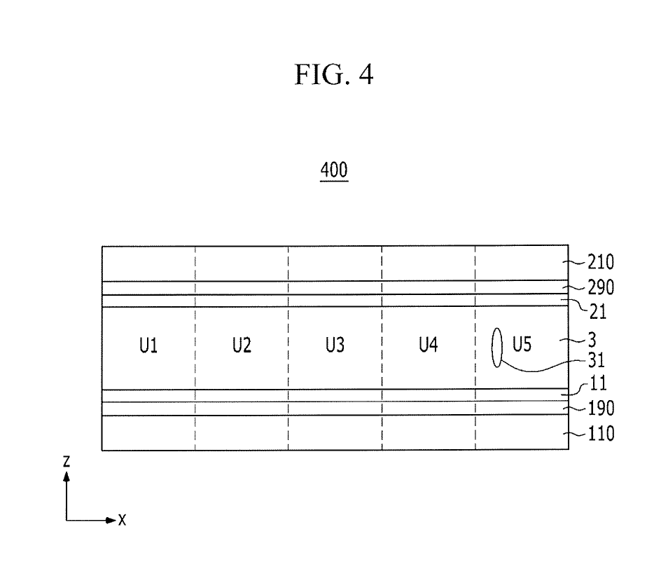

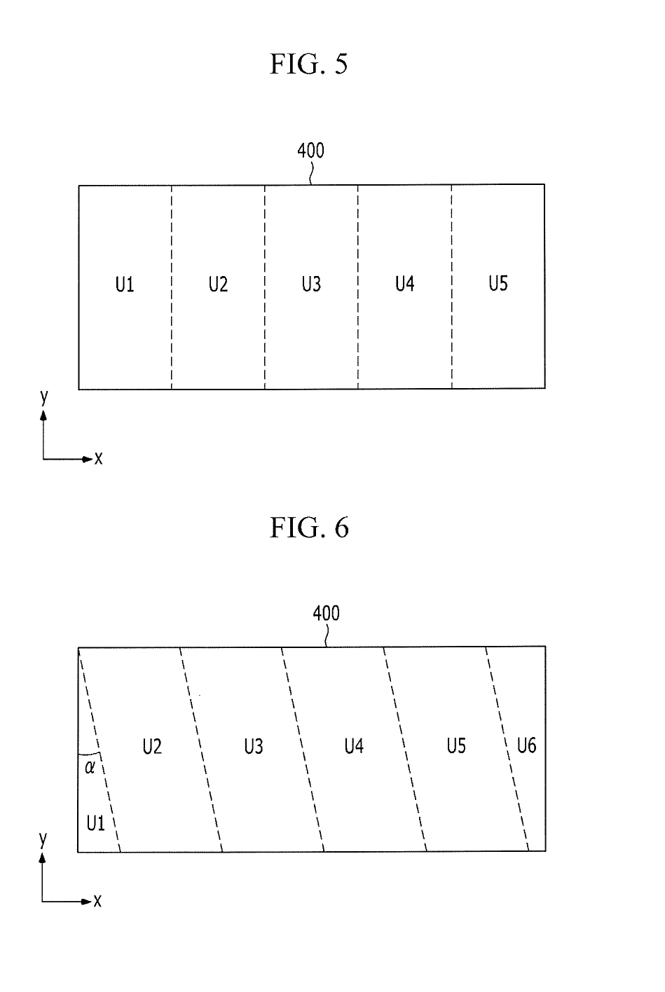

FIG. 3 is a perspective view of a liquid crystal lens panel included in a display device according to an exemplary embodiment of the present disclosure. FIG. 4 is a cross-sectional view of a liquid crystal lens panel of FIG. 3 taken along line IV-IV. FIG. 5 is one example of a plan view in an xy plane of a liquid crystal lens panel of FIG. 3.

Referring to FIGS. 3 to 5, the liquid crystal lens panel 400 includes a plurality of unit elements U1 to U5 which is sequentially positioned in an x-axis direction. One unit element covers N views of the display panel 300, where N is a natural number. One view corresponds to one pixel. For example, one unit element may cover 9 views. One unit element may function as one lens.

The liquid crystal lens panel 400 includes a first substrate 110 and a second substrate 210 which may be made of an insulating material such as glass, plastic, etc., and that face each other, and a liquid crystal layer 3 interposed between the two substrates 110 and 210.

A first electrode layer 190 and a first alignment layer 11 are sequentially disposed on the first substrate 110. A second electrode layer 290 and a second alignment layer 21 are sequentially disposed on the second substrate 210. The first electrode layer 190 and the second electrode layer 290 may be made of a transparent conductive material such as Indium tin oxide (ITO) or Indium zinc oxide (IZO). The first electrode layer 190 may be patterned to form a plurality of linear electrodes. The second electrode layer 290 may be a single plate electrode without a separate pattern. The second electrode layer 290 may correspond to the display area of the display panel 300.

In FIG. 5, a boundary between the unit elements U1 to U5 of the liquid crystal lens panel 400 may be parallel to a y axis.

FIG. 6 is another example of the plan view in the xy plane of a liquid crystal lens panel of FIG. 3.

Referring to FIG. 6, the liquid crystal lens panel 400 includes a plurality of unit elements U1 to U6 and a boundary between the unit elements U1 to U6 is tilted with respect to the y axis by an angle α. For example, α may be from about 10° to about 30°.

Hereinafter, it may be assumed that in the liquid crystal lens panel 400, the boundary between the unit elements U1 to U6 is tilted with respect to the y axis by an angle α.

Referring back to FIG. 4, the first electrode layer 190 and the second electrode layer 290 generate an electric field in the liquid crystal layer 3 based on an applied voltage to control alignment of liquid crystal molecules 31 of the liquid crystal layer 3. The alignment layers 11 and 21 determine an initial alignment of the liquid crystal molecules 31 of the liquid crystal layer 3. The liquid crystal layer 3 may be initially aligned in one of various modes such as a horizontal alignment mode, a vertical alignment mode, and a twisted nematic (TN) mode.

The liquid crystal lens panel 400 may operate in 2D mode or 3D mode based on the voltages applied to the first electrode layer 190 and the second electrode layer 290. When no voltages are applied to the first electrode layer 190 and the second electrode layer 290, the liquid crystal lens panel 400 operates in 2D mode. When voltages are applied to the first electrode layer 190 and the second electrode layer 290, the liquid crystal lens panel 400 operates in 3D mode. To this end, an initial-alignment direction of the liquid crystal molecules 31 may be appropriately controlled.

When the liquid crystal lens panel 400 operates in 3D mode, each unit element U1 to U5 of the liquid crystal lens panel 400 serves as one lens. The liquid crystal molecules 31 may be initially aligned so that each unit element U1 to U5 of the liquid crystal lens panel 400 serves as one lens.

Hereinafter, the liquid crystal lens panel 400 operating in 3D mode will be described.

The plurality of unit elements U1 to U5 in the liquid crystal lens panel 400 operating in 3D mode may be repeated at regular intervals in one direction of the liquid crystal lens panel 400. A position of the unit elements U1 to U5 in the liquid crystal lens panel 400 may be fixed, and the unit elements U1 to U may change with time.

One unit element may be implemented as a Fresnel zone plate. A Fresnel zone plate is a device that serves as a lens by diffracting light instead of refracting light by using a plurality of concentric circles which are radially arranged as in a Fresnel lens and whose widths decrease with increasing distance from a center of the Fresnel zone plate.

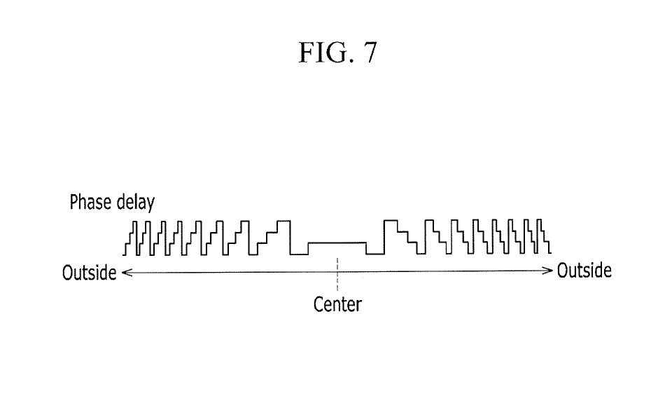

FIG. 7 is a graph that illustrates a phase delay change according to a position of a phase modulation type Fresnel zone plate. Here, each zone of the Fresnel zone plate is a region to which each waveform is repeated in the graph.

Referring to FIG. 7, a phase delay in each zone change stepwise. In a zone at the center, the phase delay changes by two steps, and in zone outside the center, the phase delay changes by four steps. However, the number of steps in the phase delay is exemplary and non-limiting, and may change in each zone.

A Fresnel zone plate as shown in FIG. 7, in which the phase delay changes stepwise in each zone, is called a multi-level phase modulation zone plate. The liquid crystal lens panel 400 may refract light to a focus position through refraction and destructive and constructive interference of light passing through each zone. As such, a lens effect may be generated by forming a phase delay distribution using a Fresnel zone plate that corresponds to each of the unit elements U1 to U5 of the liquid crystal lens panel 400.

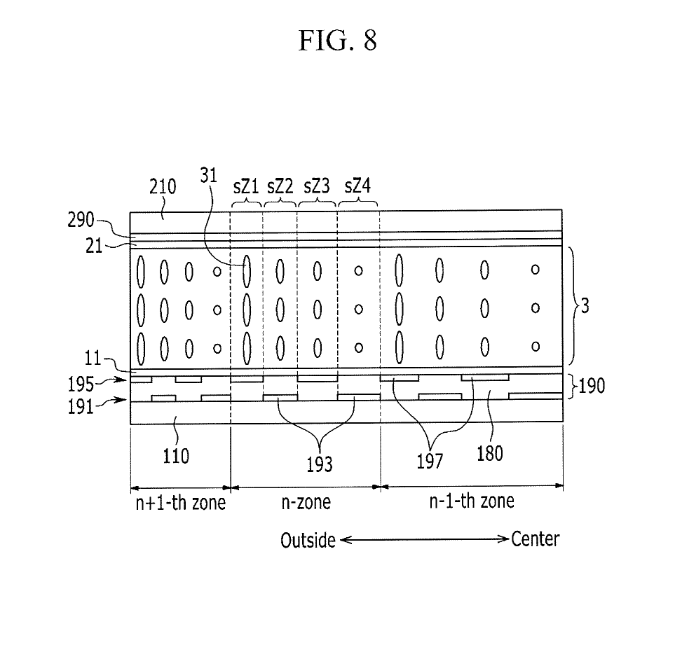

FIG. 8 is a cross-sectional view that illustrates a part of a unit lens in a unit element according to an exemplary embodiment of the present disclosure.

Referring to FIG. 8, a unit element includes a first substrate 110 and a second substrate 210 that face each other, and a liquid crystal layer 3 interposed between the two substrates 110 and 210. A first electrode layer 190 and an alignment layer 11 are sequentially formed on the first substrate 110, and a second electrode layer 290 and an alignment layer 21 are sequentially formed on the second substrate 210.

The first electrode layer 190 may include a first electrode array 191 that includes a plurality of first electrodes 193, an insulating layer 180 formed on the first electrode array 191, and a second electrode array 195 formed on the insulating layer 180 that includes a plurality of second electrodes 197.

The first electrodes 193 and the second electrodes 197 are alternately positioned in a horizontal direction and may not overlap each other. FIG. 8 shows the edges of adjacent first and second electrodes 193 and 197 as not overlapping with each other, but in other embodiments, some edges may also slightly overlap with each other.

A horizontal width of the first electrode 193 and the second electrode 197, a distance between the first electrodes 193, and a distance between the second electrodes 197, may gradually decrease toward the outer side from the center of the unit lens and may gradually decrease toward the outer side from the center in each zone. The first and second electrodes 193 and 197 are positioned in each zone of the unit lens, such as an n−1-th zone, an n-th zone, and an n+1-th zone, and a region where each first and second electrode 193 and 197 are positioned in each zone forms one sub-zone sZ1, sZ2, sZ3, sZ4, . . . . In one zone, the sub-zones are represented as sZ1, sZ2, sZ3, and sZ4 in sequence from the outer side toward the center of the zone plate. Although FIG. 8 shows that one zone includes four sub-zones sZ1, sZ2, sZ3, and sZ4, in other embodiments, the number of sub-zones is not limited thereto. Unlike those illustrated in FIG. 8, the horizontal widths of the first electrode 193 and the second electrode 197 included in one zone may be uniform, and the number of electrodes 193 and 197 included in each zone may also decrease toward the outer zone of the zone plate.

In all zones, the horizontal widths of the first electrode 193 and the second electrode 197 may be greater than or equal to a cell gap of the liquid crystal layer 3. However, due to processing limits and a liquid crystal refractive index limit, there is a limit to how much the cell gap may be reduced.

The insulating layer 180 may be made of an inorganic insulating material, an organic insulating material, etc., and electrically insulates the first electrode array 191 and the second electrode array 195 from each other.

The second electrode layer 290 is formed on the entire surface of the second substrate 210 and receives a predetermined voltage, such as a common voltage Vcom. The second electrode layer 290 may be made of a transparent conductive material such as ITO or IZO.

The alignment layers 11 and 21 may be rubbed in a longitudinal direction, which is a direction vertical to a surface of the drawing and which is vertical to a lateral direction of the first and second electrodes 193 and 197, or a direction that forms a predetermined angle with the longitudinal direction. The rubbing directions of the alignment layer 11 and the alignment layer 21 may be opposite to each other.

The liquid crystal molecules 31 of the liquid crystal layer 3 may be initially aligned in a direction horizontal to the surfaces of the substrates 110 and 210, but the alignment mode of the liquid crystal layer 3 is not limited thereto and may have a vertical alignment, etc.

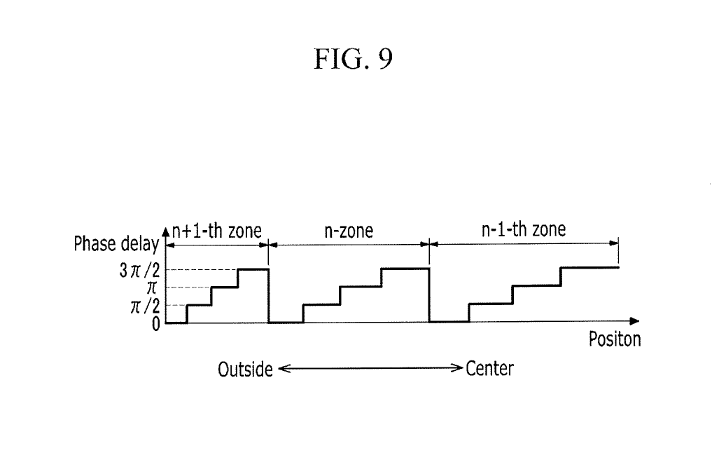

FIG. 9 illustrates a phase delay as a function of position in a unit element of FIG. 8 according to an exemplary embodiment of the present disclosure. Here, the unit element may be implemented by a phase modulation type Fresnel zone plate for each unit lens.

Referring to FIG. 9, a phase delay in each of the n−1-th zone, the n-th zone, and the n+1-th zone of the unit lens changes by four steps, by π/2 each step. In each of the plurality of zones, the phase delay increases stepwise from the outer side to the center. The same sub-zone in each zone causes the same phase delay. A slope of the phase delay at a zone boundary position is vertical.

In a diffractive element, a phase delay according to a position may be implemented by controlling a voltage applied to the diffractive element. However, at the zone boundary, it may be challenging to implement a vertical phase delay slope. That is, it may be challenging to control the phase delay at the zone boundary. To easily control the phase delay, the cell gap of the liquid crystal layer may be decreased, but due to processing limits and the liquid crystal refractive index limit, there is a limit to how much the cell gap may be decreased.

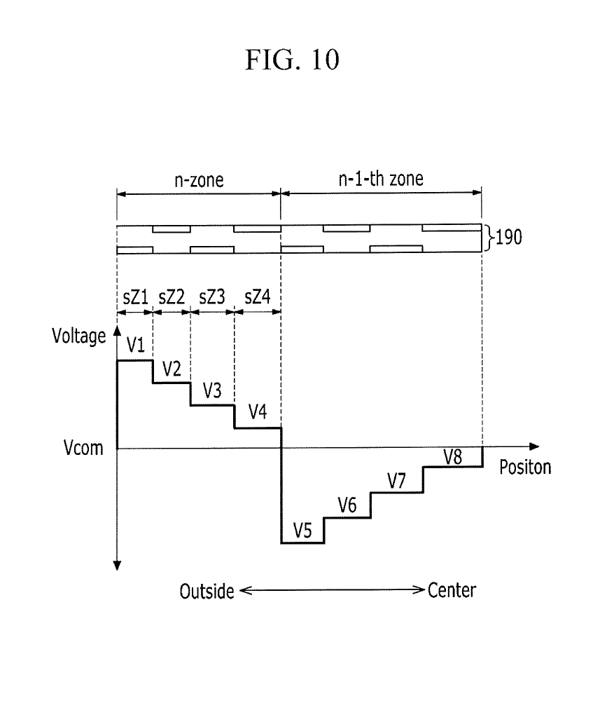

FIG. 10 illustrates an example of a voltage applied to a first electrode layer of a unit element in a liquid crystal lens panel according to an exemplary embodiment of the present disclosure.

Referring to FIG. 10, in a unit element, a positive (+) voltage with respect to the common voltage Vcom is applied to the n-th zone of the unit lens and a negative (−) voltage with respect to the common voltage Vcom is applied to the n−1-th zone of the unit lens. The common voltage Vcom is applied to the second electrode layer 290 (see FIG. 8) of the unit element. As such, a polarity of the voltage applied to the first electrode layer 190 with respect to the common voltage Vcom is inverted for each zone.

Spatial inversion of the voltage may be performed together with temporal inversion in which a positive (+) voltage changes into a negative (−) voltage and a negative (−) voltage changes into a positive (+) voltage at regular intervals.

The first electrode layer 190 of each zone receives a stepped voltage in which a difference with respect to the common voltage Vcom gradually decreases from the outer side to the center. Hereinafter, voltages applied to sub-zones sZ1, sZ2, sZ3, and sZ4 of the n-th zone and the n−1-th zone from the outer side to the center are referred to as V1, . . . , V8 in sequence.

When the polarity of the voltage of the n-th zone is positive (+) and the polarity of the voltage of the n−1-th zone is negative (−), the phase delay due to voltages V1 to V8 with respect to the common voltage Vcom may satisfy the following Equation 1.

P(V1−Vcom)=P(V5−Vcom)

P(V2−Vcom)=P(V6−Vcom)

P(V3−Vcom)=P(V7−Vcom)

P(V4−Vcom)=P(V8−Vcom) (Equation 1)

Here, P(V) represents a phase delay of light having a specific single wavelength which is vertically incident to the liquid crystal layer, when upper liquid crystal directors of the corresponding electrode are rearranged due to a difference V between the voltages applied to each electrode and the common electrode.

A difference between central voltages V4 and V8 applied to the electrode positioned at a centermost side of each zone and the common voltage Vcom may be referred to as an offset voltage a, where a=V4−Vcom or Vcom−V8. In FIG. 10, the offset voltage a is greater than 0, but the offset voltage a may vary according to the position of a zone even in one unit lens.

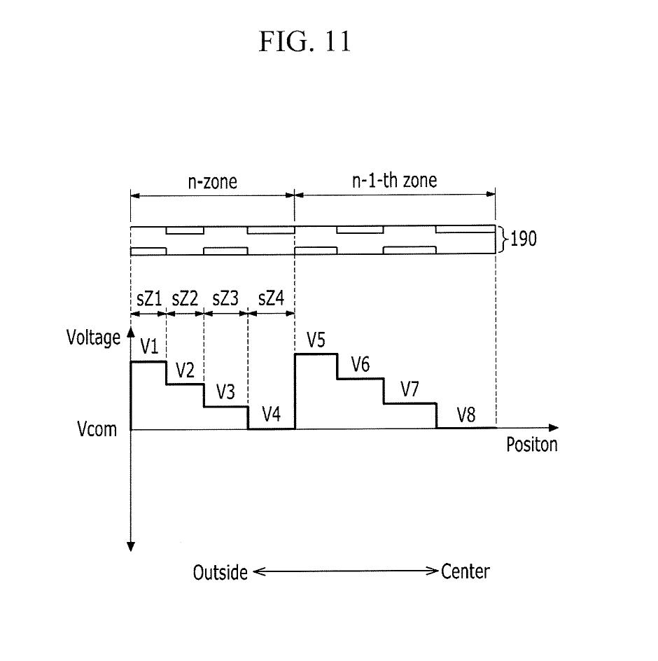

FIG. 11 illustrates another example of a voltage applied to a first electrode layer of a unit element in a liquid crystal lens panel according to an exemplary embodiment of the present disclosure.

Referring to FIG. 11, a positive (+) voltage with respect to the common voltage Vcom is applied to each zone of the unit lens of the unit element. That is, positive (+) voltages with respect to the common voltage Vcom are applied to the n-th zone and the n−1-th zone of the unit lens. The first electrode layer 190 of each zone receives a stepped voltage in which a difference with the common voltage Vcom gradually decrease from the outer side of the zone to the center. Voltages V1, V2, V3, and V4 applied to the n-th zone may be the same as or different from voltages V5, V6, V7, and V8 applied to the n−1-th zone, respectively.

Alternatively, in contrast to those illustrated in FIG. 11, negative (−) voltages with respect to the common voltage Vcom may be applied to each zone of the unit lens of the unit element.

As such, a polarity of the voltages applied to the first electrode layer 190 with respect to the common voltage Vcom do not invert for each zone, but rather have the same polarities.

Hereinafter, a wire structure for supplying voltages to the first electrode layer 190 in the liquid crystal lens panel 400 will be described.

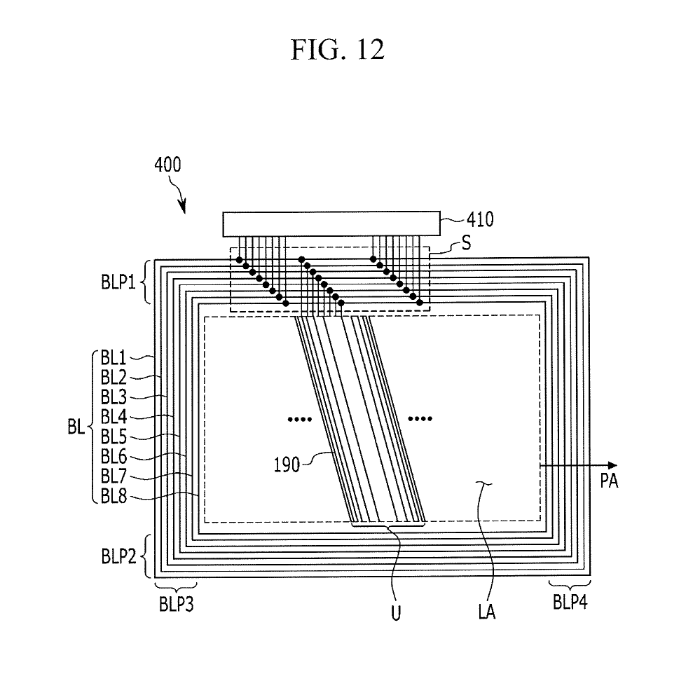

FIG. 12 is a plan view that illustrates a wire structure of a liquid crystal lens panel according to an exemplary embodiment of the present disclosure.

Referring to FIG. 12, the liquid crystal lens panel 400 can implement a lens by controlling an alignment distribution of the liquid crystals, which may be divided into a lens area LA in which a 3D image is displayed and a peripheral area PA positioned around the lens area LA in which no image is displayed. In FIG. 12, a region inside of a dotted line is the lens area LA and a region outside of the dotted line which surrounds the lens area LA is the peripheral area PA.

In the lens area LA, linear electrodes of the first electrode layer 190, which form the plurality of unit elements U described above, are disposed.

In the peripheral area PA, a plurality of bus lines BL are disposed. Here, eight bus lines BL1 to BL8 are illustrated, but this is exemplary and non-limiting, and the number of bus lines BL is not limited thereto. The number of bus lines BL may vary according to the number of electrodes that configure the unit element U or the number of electrodes that configure in each zone.

The plurality of bus lines BL includes an upper bus line part BLP1, a lower bus line part BLP2, a left bus line part BLP3, and a right bus line part BLP4. As illustrated in the drawing, the upper bus line part BLP1 and the lower bus line part BLP2 are positioned along a long side of the peripheral area PA, and the left bus line part BLP3 and the right bus line part BLP4 are positioned along a short side of the peripheral area PA. The plurality of bus lines BL continuously surrounds the lens area LA. That is, the upper bus line part BLP1, the lower bus line part BLP2, the left bus line part BLP3, and the right bus line part BLP4 are connected to each other to form one plurality of lines. Each of the plurality of bus lines BL forms one route. The plurality of bus lines BL may be made of a low resistance, opaque metal such as copper or aluminum.

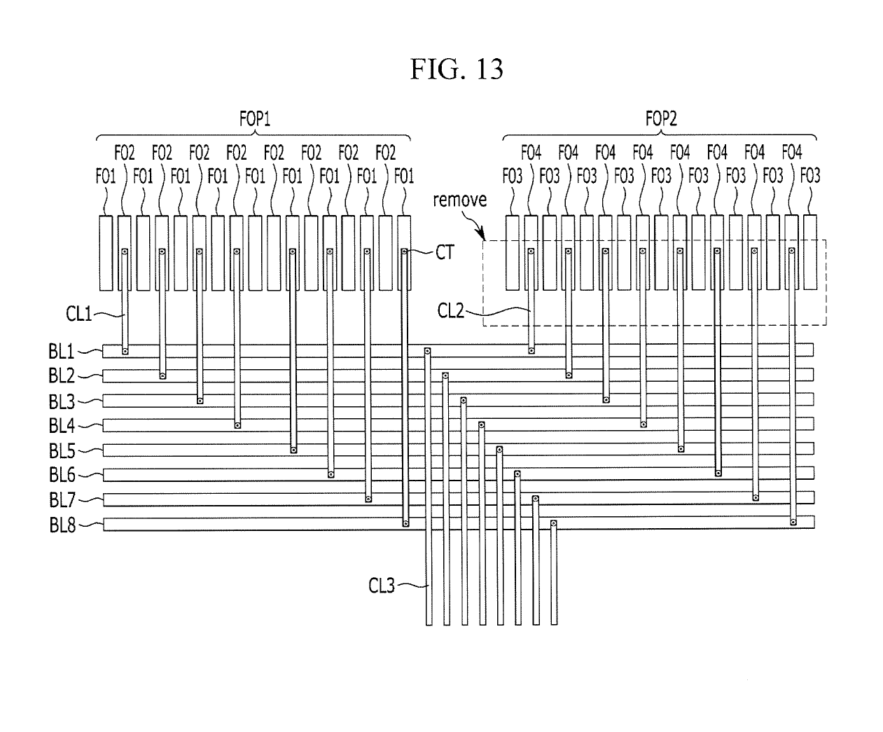

A lens driving unit 410 adjacent to the upper bus line part BLP1 may be disposed in the peripheral area PA. The lens driving unit 410 generates a lens voltage supplied to the first electrode layer 190 via the plurality of bus lines BL. Each of the linear electrodes of the first electrode layer 190 that forms the plurality of unit elements U in the lens area LA is connected to one of the plurality of bus lines BL. A wire structure that connects the lens driving unit 410, the plurality of bus lines BL, and the linear electrodes of the first electrode layer 190 will be described below with reference to FIGS. 13 to 16.

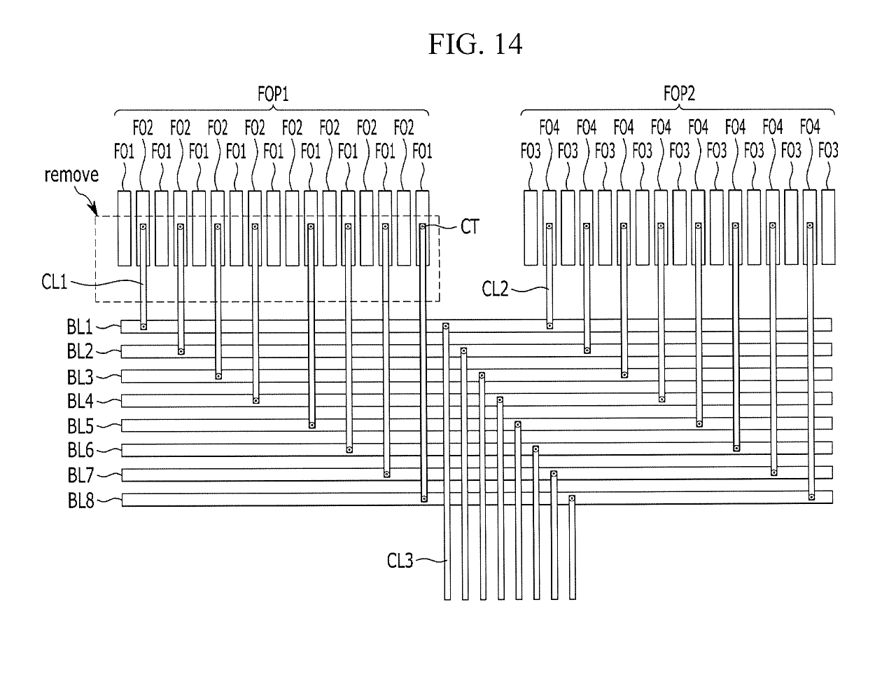

FIGS. 13 and 14 illustrate one example of a wire structure a region S of FIG. 12.

Referring to FIGS. 13 and 14, two fanout parts FOP1 and FOP2 are connected to the lens driving unit 410, and the lens voltage may be supplied to the plurality of bus lines BL through any one of the two fanout parts FOP1 and FOP2.

The first fanout part FOP1 includes a plurality of first fanout wires FO1 and a plurality of second fanout wires FO2, both of which are connected to the lens driving unit 410. The lens driving unit 410 may output negative (−) voltages with respect to the common voltage Vcom to the plurality of first fanout wires FO1 and may output positive (+) voltages with respect to the common voltage Vcom to the plurality of second fanout wires FO2. The magnitudes of the negative (−) voltages applied to the plurality of first fanout wires FO1 and of the positive (+) voltages applied to the plurality of second fanout wires FO2 may differ from each other.

In the first fanout part FOP1, some of the plurality of first fanout wires FO1 and some of the plurality of second fanout wires FO2 are selectively connected to the plurality of bus lines BL1 to BL8 through a plurality of first connection wires CL1. As illustrated in the drawing, four second fanout wires FO2 are connected to four bus lines BL1 to BL4 through four first connection wires CL1, respectively. In addition, four first fanout wires FO1 are connected to four bus lines BL5 to BL8 through four first connection wires CL1, respectively. The first fanout wires FO1 and first connection wires CL1, the second fanout wires FO2 and the first connection wires CL1, and the first connection wires CL1 and the bus lines BL may be electrically connected to each other through contact holes CT, respectively.

The second fanout part FOP2 includes a plurality of third fanout wires FO3 and a plurality of fourth fanout wires FO4, both of which are connected to the lens driving unit 410. The lens driving unit 410 may output negative (−) voltages with respect to the common voltage Vcom to the plurality of third fanout wires FO3 and may output positive (+) voltages with respect to the common voltage Vcom to the plurality of fourth fanout wires FO4. Magnitudes of the negative (−) voltages applied to the plurality of third fanout wires FO3, and of the positive (+) voltages applied to the plurality of fourth fanout wires FO4 may differ from each other.

In the second fanout part FOP2, the plurality of fourth fanout wires FO4 are selectively connected to the plurality of bus lines BL1 to BL8 through a plurality of second connection wires CL2. As illustrated in the drawing, eight fourth fanout wires FO4 are connected to eight bus lines BL1 to BL8 through eight second connection wires CL2, respectively. The fourth fanout wires FO4 and the second connection wires CL2, and the second connection wires CL2 and the bus lines BL may be electrically connected to each other through each contact holes CT, respectively.

A plurality of third connection wires CL3 connected to the respective linear electrodes of the first electrode layer 190 are connected to the plurality of bus lines BL1 to BL8, respectively. The plurality of third connection wires CL3 and the plurality of bus lines BL1 to BL8 may be electrically connected to each other through the contact holes CT. In this case, the third connection wires CL3 may connect the first to fourth bus lines BL1 to BL4 to linear electrodes of one zone, and the fifth to eighth bus lines BL5 to BL8 to linear electrodes of an adjacent zone.

The plurality of first connection wires CL1, the plurality of second connection wires CL2, and the plurality of third connection wires CL3 may be made of a transparent conductive material such as indium tin oxide (ITO) or indium zinc oxide (IZO).

In a manufacturing process of the liquid crystal lens panel 400, the first fanout part FOP1 and the second fanout part FOP2 may be connected to the plurality of bus lines BL1 to BL8 as described above. When a driving method of the liquid crystal lens panel 400 is an inversion method, in which the polarity of voltages applied to the first electrode layer 190 is inverted for each zone, or a non-inversion method, in which the polarity of voltages are not inverted for each zone, one of the first and second fanout parts FOP1 and FOP2 may be disconnected from each other based on the driving method. In the connections between the first fanout part FOP1 and the plurality of bus lines BL1 to BL8 or the connections between the second fanout part FOP2 and the plurality of bus lines BL1 to BL8, a corresponding portion may be disconnected using a mask.

The non-limiting example shown in FIG. 13, in which the second fanout part FOP2 and the plurality of bus lines BL1 to BL8 are disconnected from each other, will be described. Through the first fanout part FOP1, a positive lens voltage may be applied to the first to fourth bus lines BL1 to BL4, and a negative lens voltage may be applied to the fifth to eighth bus lines BL5 to BL8. As a result, linear electrodes of one zone that are connected to the first to fourth bus lines BL1 to BL4 receive the positive lens voltage, and linear electrodes of the other adjacent zone that are connected to the fifth to eighth bus lines BL5 to BL8 receive the negative lens voltage. For example, as illustrated in FIG. 10, the polarity of the voltage applied to the first electrode layer 190 with respect to the common voltage Vcom may be inverted for each zone.

The non-limiting example shown in in FIG. 14, in which the first fanout part FOP1 and the plurality of bus lines BL1 to BL8 are disconnected from each other, will be described. A positive lens voltage may be applied to the first to eighth bus lines BL1 to BL8 through the second fanout part FOP2. As a result, linear electrodes of one zone that are connected to the first to fourth bus lines BL1 to BL4 receive the positive lens voltage, and the linear electrodes of the other adjacent zone that are connected to the fifth to eighth bus lines BL5 to BL8 also receive the positive lens voltage. For example, as illustrated in FIG. 11, the polarity of the voltages applied to the first electrode layer 190 with respect to the common voltage Vcom are not inverted for each zone.

As described above, in a manufacturing process of the liquid crystal lens panel 400, the first fanout part FOP1 and the second fanout part FOP2 are connected to the plurality of bus lines BL1 to BL8 by different methods, and then any one of the first and second fanout parts FOP1 and FOP2 may be disconnected from the plurality of bus lines BL1 to BL8 based on a driving method of the liquid crystal lens panel 400. As a result, it is possible to manufacture the liquid crystal lens panel 400 which may be used with both an inversion driving method and a non-inversion driving method. That is, it is unnecessary to manufacture separate wire structures for the liquid crystal lens panel 400 to accommodate different driving methods of the liquid crystal lens panel 400.

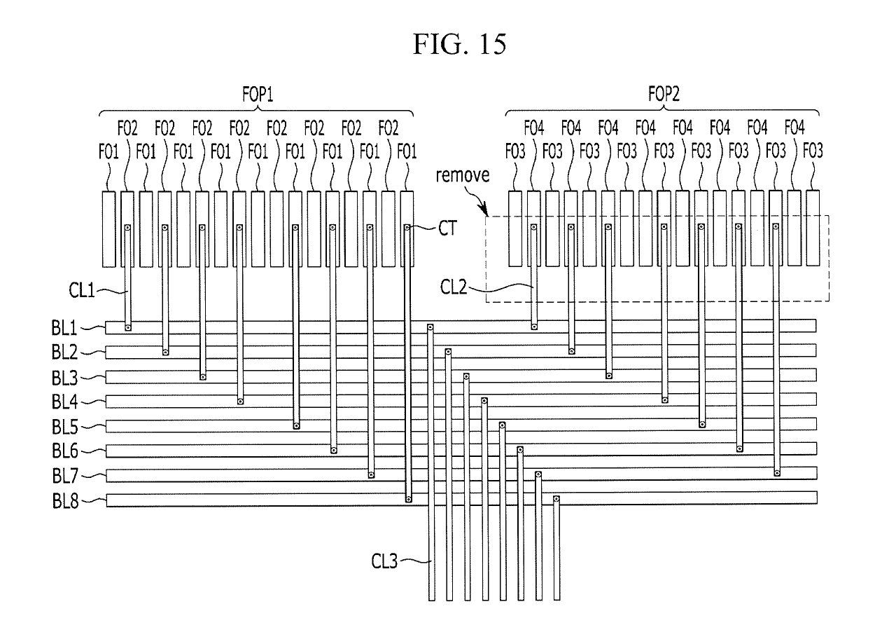

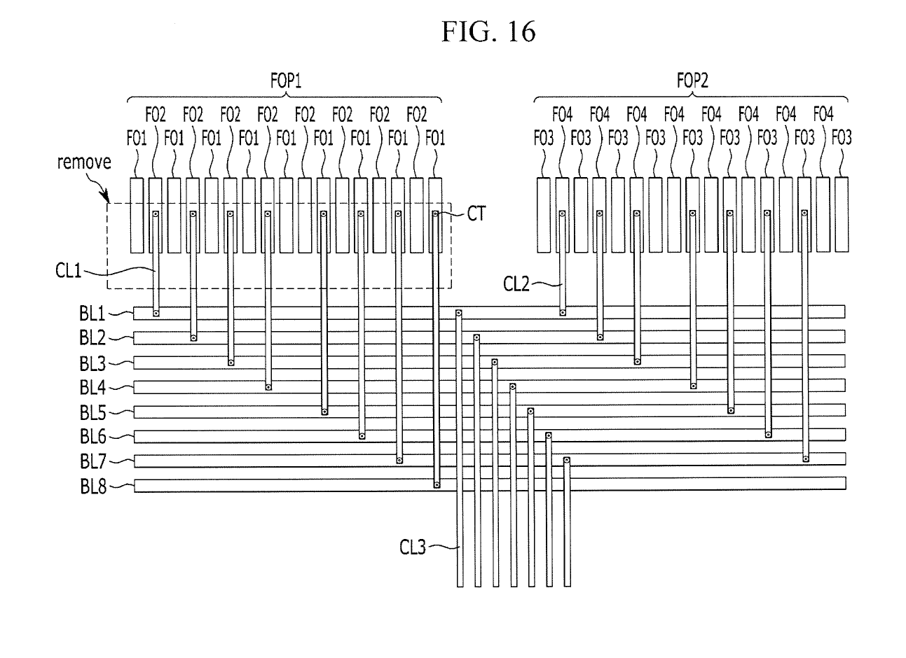

FIGS. 15 and 16 illustrate another example of a wire structure of the region S of FIG. 12.

First, referring to FIGS. 15 and 16, a configuration in which a plurality of first and second fanout wires FO1 and FO2 of the first fanout part FOP1 are selectively connected to the plurality of bus lines BL1 to BL8 through a plurality of first connection wires CL1 is the same as that of FIG. 13.

In the second fanout part FOP2, three fourth fanout wires FO4 are connected to three bus lines BL1 to BL3 through three second connection wires CL2, respectively. In addition, four third fanout wires FO3 are connected to four bus lines BL4 to BL7 through four second connection wires CL2, respectively. As opposed to FIG. 13, the voltages applied the plurality of bus lines BL1 to BL8 in the second fanout part FOP2 are not all positive. Rather, positive lens voltages are applied to the first to third bus lines BL1 to BL3 of the plurality of bus lines BL1 to BL8, and negative lens voltages are applied to the fourth to seventh bus lines BL4 to BL7, so that the polarity of the voltages may be inverted for each zone. However, in the first fanout part FOP1, while positive lens voltages are applied to four bus lines BL1 to BL4, in the second fanout part FOP2, positive lens voltages are applied to the three bus lines BL1 to BL3. That is, the polarity of the voltages applied to the plurality of bus lines BL1 to BL8 through the first fanout part FOP1 and the polarity of the voltages applied to the plurality of bus lines BL1 to BL8 through the second fanout part FOP2 may vary in at least one bus line.

As illustrated in FIG. 15, to configure the unit element U so that four linear electrodes belong to one zone and four linear electrodes belong to an adjacent zone, the linear electrodes of one zone may be connected to the first to fourth bus lines BL1 to BL4 using the plurality of third connection wires CL3, and the linear electrodes of the other adjacent zone may be connected to the fifth to eighth bus lines BL5 to BL8 using the plurality of third connection wires CL3. In addition, the second fanout part FOP2 and the plurality of bus lines BL1 to BL8 may be disconnected from each other. Through the first fanout part FOP1, a positive lens voltage may applied to the first to fourth bus lines BL1 to BL4, and a negative lens voltage may applied to the fifth to eighth bus lines BL5 to BL8. As a result, the linear electrodes of one zone that are connected to the first to fourth bus lines BL1 to BL4 receive positive lens voltages, and the linear electrodes of the other adjacent zone that are connected to the fifth to eighth bus lines BL5 to BL8 receive negative lens voltages. The polarity of the voltages applied to the first electrode layer 190 with respect to the common voltage Vcom is inverted for each zone.

As illustrated in FIG. 16, to configure the unit element U so that four linear electrodes belong to one zone and three linear electrodes belong to an adjacent zone, the linear electrodes of one zone are connected to the first to third bus lines BL1 to BL3 using the plurality of third connection wires CL3, and the linear electrodes of the other adjacent zone may be connected to the fourth to seventh bus lines BL4 to BL7 using the plurality of third connection wires CL3. In addition, the first fanout part FOP1 and the plurality of bus lines BL1 to BL8 may be disconnected from each other. Then, through the second fanout part FOP2, a positive lens voltage may be applied to the first to third bus lines BL1 to BL3, and a negative lens voltage may be applied to the fourth to seventh bus lines BL4 to BL7. As a result, the linear electrodes of one zone that are connected to the first to third bus lines BL1 to BL3 receive positive lens voltages, and the linear electrodes of the other adjacent zone that are connected to the fourth to seventh bus lines BL4 to BL7 receive negative lens voltages. Similar to FIG. 15, the polarity of the voltage applied to the first electrode layer 190 with respect to the common voltage Vcom is inverted for each zone. However, in FIG. 16, there is a difference in the number of linear electrodes which belong to the zone, and a magnitude of the lens voltage applied to each zone varies.

As described above, in a manufacturing process of the liquid crystal lens panel 400, the first fanout part FOP1 and the second fanout part FOP2 are connected to the plurality of bus lines BL1 to BL8 by different methods, and then any one of the first and second fanout parts FOP1 and FOP2 and the plurality of bus lines BL1 to BL8 may be disconnected from each other based on the number of linear electrodes which belong to the zone of the unit element U and a magnitude of the voltage applied to the zone. As a result, the magnitude of the lens voltages applied to the zone may be changed by the wire configuration.

While this disclosure has been described with respect to what are presently considered to be practical exemplary embodiments, it is to be understood that embodiments of the disclosure are not limited to the disclosed embodiments, but, on the contrary, are intended to cover various modifications and equivalent arrangements included within the spirit and scope of the appended claims.

What is claimed is:

1. A liquid crystal lens panel, comprising:
a lens driving unit configured to generate a lens voltage for controlling an alignment distribution of a liquid crystal;
a first fanout part that includes a plurality of first fanout wires and a plurality of second fanout wires which are connected to the lens driving unit;
a second fanout part that includes a plurality of third fanout wires and a plurality of fourth fanout wires which are connected to the lens driving unit;
a plurality of bus lines disposed to surround a lens area in which a lens shape is implemented;
a plurality of first connection wires that connect at least some of the plurality of first fanout wires to the plurality of bus lines and at least some of the plurality of second fanout wires to the plurality of bus lines; and
a plurality of second connection wires that connect at most some of the plurality of third fanout wires to the plurality of bus lines and at least some of the plurality of fourth fanout wires to the plurality of bus lines,
wherein the first fanout part and the plurality of bus lines or the second fanout part and the plurality of bus lines are disconnected from each other.

2. The liquid crystal lens panel of claim 1, wherein:
the lens driving unit outputs negative voltages with respect to a common voltage to the plurality of first fanout wires and outputs positive voltages with respect to the common voltage to the plurality of second fanout wires.

3. The liquid crystal lens panel of claim 2, wherein:
magnitudes of negative voltages applied to the plurality of first fanout wires differ from each other, and
magnitudes of positive voltages applied to the plurality of second fanout wires differ from each other.

4. The liquid crystal lens panel of claim 1, wherein:
the lens driving unit outputs negative voltages with respect to a common voltage to the plurality of third fanout wires and outputs positive voltages with respect to the common voltage to the plurality of fourth fanout wires.

5. The liquid crystal lens panel of claim 4, wherein:
magnitudes of negative voltages applied to the plurality of third fanout wires differ from each other, and
magnitudes of positive voltages applied to the plurality of fourth fanout wires differ from each other.

6. The liquid crystal lens panel of claim 1, further comprising:
a plurality of linear electrodes disposed in the lens area, wherein groups of adjacent linear electrodes are formed into zones;
a plate electrode disposed to face the plurality of linear electrodes and to which a common voltage is applied; and
a liquid crystal layer interposed between the plurality of linear electrodes and the plate electrode.

7. The liquid crystal lens panel of claim 6, further comprising:
a plurality of third connection wires which connect the plurality of linear electrodes and the plurality of bus lines.

8. The liquid crystal lens panel of claim 6, wherein:
when the first fanout part and the plurality of bus lines are disconnected from each other, the liquid crystal lens panel is driven by a non-inversion method in which a polarity of the voltages applied to the plurality of linear electrodes is not inverted for each zone.

9. The liquid crystal lens panel of claim 6, wherein:
when the second fanout part and the plurality of bus lines are disconnected from each other, the liquid crystal lens panel is driven by an inversion method in which a polarity of the voltages applied to the plurality of linear electrodes is inverted for each zone.

10. The liquid crystal lens panel of claim 1, wherein:
a polarity of the voltages applied to the plurality of bus lines through the first fanout part and a polarity of the voltages applied to the plurality of bus lines through the second fanout part differ from each other in at least one bus line.

11. A liquid crystal lens panel, comprising:
a plurality of linear electrodes disposed in a lens area of the liquid crystal lens panel, wherein groups of adjacent linear electrodes are formed into zones;
a plate electrode disposed to face the plurality of linear electrodes and to which a predetermined common voltage is applied;
a lens driving unit configured to generate a lens voltage applied to the plurality of linear electrodes;
a first fanout part that includes a plurality of first fanout wires and a plurality of second fanout wires which are connected to the lens driving unit;
a second fanout part that includes a plurality of third fanout wires and a plurality of fourth fanout wires which are connected to the lens driving unit; and
a plurality of bus lines disposed in a peripheral area of the liquid crystal lens panel that surrounds the lens area and that are connected to the plurality of linear electrodes,
wherein a polarity of the voltages applied to the plurality of bus lines through the first fanout part and a polarity of the voltages applied to the plurality of bus lines through the second fanout part differ from each other in at least one bus line.

12. The liquid crystal lens panel of claim 11, wherein when the first fanout part and the plurality of bus lines are disconnected from each other, the liquid crystal lens panel is driven by a non-inversion method in which a polarity of the voltages applied to the plurality of linear electrodes is not inverted for each zone.

13. The liquid crystal lens panel of claim 12, wherein:
magnitudes of negative voltages applied to the plurality of first fanout wires differ from each other, and
magnitudes of positive voltages applied to the plurality of second fanout wires differ from each other.

14. The liquid crystal lens panel of claim 11, wherein when the second fanout part and the plurality of bus lines are disconnected from each other, the liquid crystal lens panel is driven by an inversion method in which a polarity of the voltages applied to the plurality of linear electrodes is inverted for each zone.

15. The liquid crystal lens panel of claim 14, wherein:
magnitudes of the negative voltages applied to the plurality of third fanout wires differ from each other, and
magnitudes of the positive voltages applied to the plurality of fourth fanout wires differ from each other.

16. The liquid crystal lens panel of claim 11, further comprising:
a plurality of first connection wires configured to connect the plurality of first fanout wires and the plurality of second fanout wires to the plurality of bus lines; and
a plurality of second connection wires configured to connect at least one of the plurality of third fanout wires and the plurality of fourth fanout wires to the plurality of bus lines.

17. The liquid crystal lens panel of claim 16, wherein:
the lens driving unit outputs negative voltages with respect to the common voltage to the plurality of first fanout wires and outputs positive voltages with respect to the common voltage to the plurality of second fanout wires.

18. The liquid crystal lens panel of claim 16, wherein:
the lens driving unit outputs negative voltages with respect to the common voltage to the plurality of third fanout wires and outputs positive voltages with respect to the common voltage to the plurality of fourth fanout wires.

19. The liquid crystal lens panel of claim 11, further comprising a liquid crystal layer interposed between the plurality of linear electrodes and the plate electrode, and
a plurality of third connection wires which connect the plurality of linear electrodes and the plurality of bus lines.

20. A display device, comprising:
a display panel configured to display an image; and
a liquid crystal lens panel positioned in front of a surface on which the image is displayed,
wherein the liquid crystal lens panel includes
a first substrate and a second substrate facing each other;
a first electrode layer including a plurality of linear electrodes which extends in first direction on the first substrate;
a second electrode layer disposed on the second substrate and to which a predetermined common voltage is applied;
a liquid crystal layer interposed between the first substrate and the second substrate;
a lens driving unit configured to generate a lens voltage for controlling an alignment distribution of a liquid crystal;
a first fanout part including a plurality of first fanout wires and a plurality of second fanout wires which are connected to the lens driving unit;
a second fanout part including a plurality of third fanout wires and a plurality of fourth fanout wires which are connected to the lens driving unit; and
a plurality of bus lines which is disposed in a peripheral area outside a lens area in which a lens shape is implemented area and that are connected to the plurality of linear electrodes,
wherein the first fanout part and the plurality of bus lines or the second fanout part and the plurality of bus lines are disconnected from each other.
